(19) United States
(12) Patent Application Publication
(10) Pub. No.: US 2009/0144548 A1
(43) Pub. Date: Jun. 4, 2009

(54) AUTHENTICATION WHILE EXCHANGING DATA IN A COMMUNICATION SYSTEM

(75) Inventors: Stavros Tzavidas, Evanston, IL (US); Rajeev Agrawal, Northbrook, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/239,880

(22) Filed: Sep. 29, 2008

Related U.S. Application Data
(60) Provisional application No. 60/991,229, filed on Nov. 30, 2007.

(51) Int. Cl. H04L 9/00

(52) U.S. Cl. 713/169

(57) ABSTRACT

An apparatus and method is described for authentication while exchanging data in a communication system includes deriving (100) an authentication signature from a shared secret, data in an existing data packet, and/or a sender identification. A next step (102) includes appending the authentication signature in an authentication field to the existing data packet. A next step (104) includes sending the data packet with the appended authentication field. A next step (106) includes receiving the data packet by a base station. A next step (108) includes verifying that the authentication field was produced by a sender possessing the shared secret. A next step (110) includes returning an acknowledgement message.

### FIELD OF THE INVENTION

The present invention relates generally to the field of communication systems, and more particularly to authentication while exchanging data in communications.

### BACKGROUND OF THE INVENTION

Authentication is an important function in communication systems, particularly so in wireless communication systems, such as WiMAX and its future releases (often referred to as WiMax Release 1.x and IEEE 802.16m protocols), UMTS, and LTE. In wireless communication systems authentication is commonly performed at the lower layers (layers one or two) but can be performed in higher layers as well. Authentication is the process of verifying the identity of a device or a user by exchanging control messages.

For authentication information sent from a mobile station to a base station, for example, if the base station is able to verify the authentication information properly, an acknowledged (ACK) message can be returned to the mobile station. If authentication information can not be verified, a not-acknowledged (NACK) message or no message can be returned. This procedure is also repeated for the base station to verify itself with the mobile station, thereby providing mutual authentication. Alternatively, explicit ACK/NACK messages need not be sent. In this case, there are only implicit acknowledgments (i.e. communication continues only if authentication succeeds, and that serves as an implicit acknowledgement). Data transmissions between the mobile station and base station cannot proceed until the two sides (MS and BS) have successfully authenticaticated each other. The above series of control messaging uses a significant amount of time (fifty milliseconds or more) before data communication can even commence. This amount of delay diminishes the communication experience.

Further, when the control message sent by one side (either mobile station or base station) is not received or the other side fails to verify the authentication credentials, a higher layer protocol such as Media Access Control (MAC) will use timers on the control plane to terminate the communication or to retransmit the control messages containing the authentication information. As used herein, MAC layer refers to any higher layer protocol such as the control plane, data plane, or application layer. In an example, if no communication is received by either the mobile station or base station, it must be assumed after some period of waiting in the higher layer that authentication has not been accomplished. In this example, a timer on a higher layer protocol determines that there is a problem, but only after a further considerable amount of time may have passed. The expiration time of the higher layer protocol timer as well as any time needed for retransmitting the control messages containing the authentication information further delays the resumption of data communications and further degrades the communication experience.

Accordingly, it is desired to provide a technique for mutual authentication between communication devices without the timing delay penalty that can occur in the prior art. It would also be of benefit if this can be accomplished without incurring significant costs or efforts in either hardware or software.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows a flow diagram of a prior art scenario for mutual authentication;

FIG. 2 shows a flow diagram of a scenario for mutual authentication, in accordance with the present invention;

FIG. 3 shows a state diagram of a scenario for mutual authentication, in accordance with the present invention; and

FIG. 4 is a flow chart of a method in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE PREFERRED EMBODIMENTS

The present invention provides a technique for mutual authentication between communication devices without the timing delay penalty that can occur in the prior art by using control messaging. This improvement is accomplished without incurring significant cost or effort.

In particular, the present invention provides mutual authentication without using control messaging, but instead during actual data communications exchange, thus allowing communicating entities to resume data exchange immediately during a handover. The term handover (HO), as used herein, refers to the process of a device transferring its communication link from one serving station to another. Mutual authentication is accomplished by using an addition header or field added to transmitted data packets, as will be described below in accordance with the present invention. The present invention utilizes this technique to result in faster handover. In addition, the present invention provides rules to protect the data stream while authentication of the other side is pending.

It should be recognized that the present invention is described herein in relation to the IEEE 802.16 (WiMax) communication system, but is not limited thereto, and is equally applicable to those other communication systems (e.g. UMTS, LTE, and wireline systems including any communication system where a device connects to a new server) that utilize authentication functions.

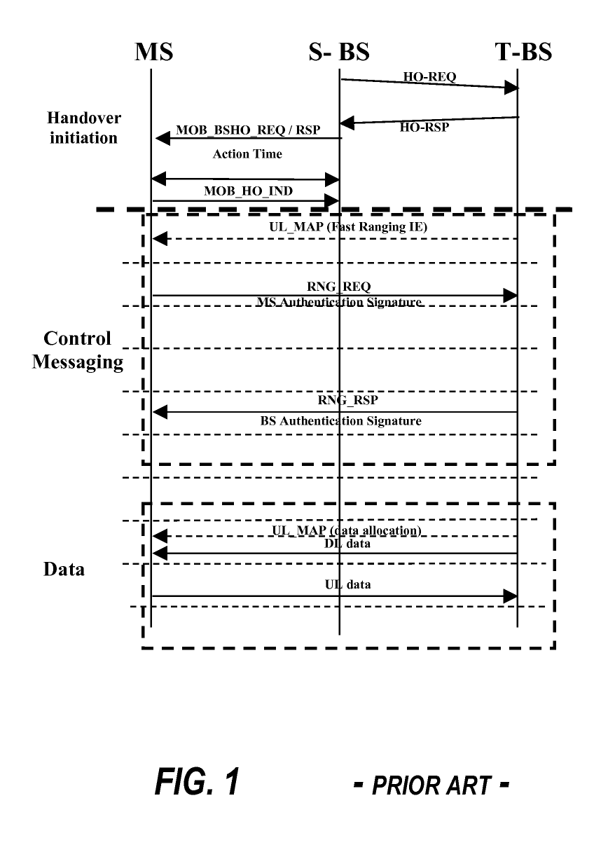

Referring to FIG. 1, a prior art handover messaging scenario is shown. In particular, a mobile station (MS) is moving from a Source Base Station (S-BS) to a Target Base Station (T-BS). In WiMAX today (and in other wireless technologies) during a handover (HO), control messages need to be exchanged before data communications that are interrupted by the HO can resume. The control message exchange serves a number of purposes: a) layer 1 (physical) adjustments, if needed, b) T-BS updates the MS basic parameters needed for communication (i.e. identification, encryption keys, etc.), and c) mutual authentication between the mobile station and base stations. The present invention demonstrates how mutual authentication can be achieved while exchanging data packets, thus allowing data to resume immediately. The other functions or purposes served by control messaging can be addressed by using methods known in the art. In other words, all the other procedures (e.g. updating the basic parameters for communication, etc.) can be done without control messages, or through communication prior to the HO.

Referring back to FIG. 1, in the current WiMAX scenario, a handover can be represented by handover initiation, exchange of control messages to provide mutual authentication, and then the resumption of data communications, as shown.

Starting with handover initiation, when a serving base station (S-BS) detects that an MS it is serving is moving into the service area of a target base station (T-BS), the S-BS will begin procedures to handover the MS to the T-BS. This begins with a handover request (HO-REQ) sent from the S-BS to the T-BS. The T-BS acknowledges this request with a handover response (HO-RSP) message. There is an action time negotiated between the S-BS and the MS that defines when the mobile station will arrive at the T-BS. In particular, the S-BS will send a mobility base station handoff request (MOB_BSHO-REQ) to the MS and wait for the MS to send a handoff indication (MOB_HO_IND) message indicating that the MS would like to transfer communication to the T-BS.

During the control messaging phase, the T-BS will use a non-contention based Fast Ranging procedure to assign a dedicated transmission opportunity to the MS for transmitting the first control message in the handover procedure, known in WiMAX as ranging request (RNG-REQ). The Fast Ranging procedure consists of sending in a start frame a UL_MAP containing a Fast Ranging Information Element (Fast Ranging IE), which assigns a transmission opportunity to the MS in a subsequent frame, typically the frame immediately following the frame where the UL_MAP is sent. The mobile station needs to arrive at the target base station by that start frame and should be looking for the Fast Ranging IE. Accordingly, the action time sent in a mobility base station handoff response (MOB_BSHO-RSP) message should be interpreted correctly between the base station and mobile station. In particular, for handover the action time value is defined as number of frames until the T-BS sends a UL_MAP containing a Fast Ranging IE, which allocates a dedicated transmission opportunity for RNG-REQ message to be transmitted by the MS.

The RNG_REQ message contains a signature calculated by the MS using a shared secret key that is previously known to the MS and the T-BS. The T-BS uses this signature to authenticate the MS in the system by confirming that the signature was generated with the shared secret key and is therefore valid. The T-BS responds to the MS with a RNG_RSP message that also contains a signature calculated by the T-BS using the shared secret key. The RNG_RSP message is generated only after RNG_REQ is received and the identity of the MS is verified. In other words, the BS makes no attempt to authenticate itself with the MS prior to receiving RNG_REQ, thus further delaying the completion of the mutual authentication procedure. The MS uses the signature received from the T-BS to authenticate the T-BS in the system by confirming that the signature was generated with the shared secret key and is therefore valid. In this way mutual authentication is achieved in the control messaging phase.

In particular, during mutual authentication, each side (MS and T-BS) proves to the other side possession of a shared secret (e.g. a shared secret key in most cases). A side proves possession of the shared secret key, by sending information within an Integrity Protection (IP) field (i.e. signature), calculated using the shared secret key. The shared secret is a key known only to MS and T-BS. Valid IP fields can be generated only by a party that possesses the shared secret (i.e. the correct key) and can be verified only by a party that possesses that same key.

The MS also receives its basic communication identification in RNG-RSP message, i.e. the last message in the control messaging phase of the handover. Before that, the MS is addressed using its MAC address or a temporary handover ID (HO-ID). The MS also receives new encryption keys from the T-BS. Currently in WiMAX, encryption keys are chosen by the T-BS (without input from the MS) and sent over-the-air to the MS in the RNG_RSP message. Encryption keys should not be confused with the shared secret (shared keys) used for authentication as described earlier, as they are separate and serve different purposes. Knowledge of encryption keys is not required for mutual authentication neither does imply knowledge of the shared keys used for authentication. Conversely, knowledge of the shared keys used for authentication does not imply knowledge of the encryption keys. The MS may receive in RNG-RSP updates for the parameters mentioned above or other parameters needed for communication with the T-BS, however it should be recognized that these parameter updates do not play a role in mutual authentication and are thus outside the scope of the present invention. As mentioned herein, parameter updates, when desired, can be accomplished by using methods known in the art.

After mutual authentication data communication can resume after handover by T-BS resuming normal downlink (DL) data communication to the MS and further sending a UL_MAP so that normal uplink (UL) data communication can resume, as is known in the art.

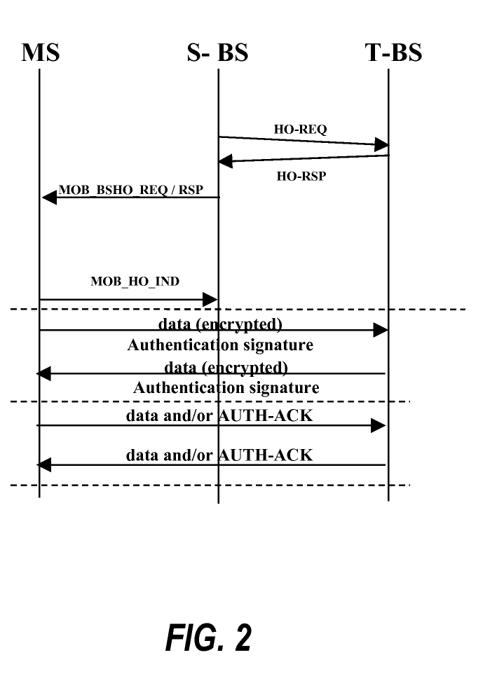

Referring to FIG. 2, the present invention enables mutual authentication through data packets instead of control messages. In particular, the present invention provides rules on how to authenticate while exchanging data and on how to handle the data packets that have been sent to a not-yet-authorized party. In addition, the present invention allows authentication of the two sides to proceed in parallel, thus minimizing delay.

The present invention initializes handover using the same HO-REQ, HO-RSP, MOB_BSHO-REQ/RSP, and MOB_HO_IND initialization messaging as described for FIG. 1 above. However, the present invention skips the previously described control messaging to establish authentication, and instead authenticates directly within data exchange. Preferably, this is accomplished within a first frame but can span multiple frames. Specifically, the MS sends its first data packet to the T-BS, with the data packet appended with a signature in a new authentication field. Unlike the prior art, the data packet includes identification of the MS (MS-ID and potentially HO-ID) and the signature is derived using one or more of the shared secret, identification, and a portion of the contents of the sent data packet.

The MS is not yet sure of identity of the other side (i.e. the T-BS) therefore it stores the data packet and also it can encrypt it, with a key that is only known to a legitimate party, so that if authentication of the T-BS fails, the contents of the data packet are not revealed. The BS follows the same steps in parallel, i.e. without waiting for input from the MS unlike the prior art, sending data packets with an appended authentication field, encrypting and storing data packets pending authentication of the MS.

Both sides, when receiving the first packet, first verify the authentication field to verify that it was produced from a sender possessing the correct shared secret. If the authentication field is verified, the other party is marked as authenticated and an ACK message is sent. Preferably, the ACK message contains a portion of the received authentication field, and the ACK is itself appended to a data packet if available. If no data packet is available at the time that the ACK needs to be sent, the ACK message can be sent alone.

All packets (including the first one) received while authentication is pending are stored and not released to the upper layers. These stored packets possibly may not be decrypted either since if authentication fails they will be discarded. If authentication of the other side succeeds, received packets are decrypted and delivered to the higher layers. If authentication failed, received packets are not decrypted and discarded.

In the present invention several preconditions are desired for best results. For example, the MS should be able to detect DL data and UL allocations that are addressed to it, and both the MS and T-BS should be capable of creating valid authentication signatures immediately after MS switches to T-BS (i.e. after L1 synchronization is done). One side cannot depend on input from the other side, otherwise more delay is introduced at the dependent side. In addition, both the MS and T-BS are desired to have valid encryption keys to encrypt data. Finally, any replay protection scheme should ensure that the sent messages (in both directions) are “fresh” i.e. not replayed.

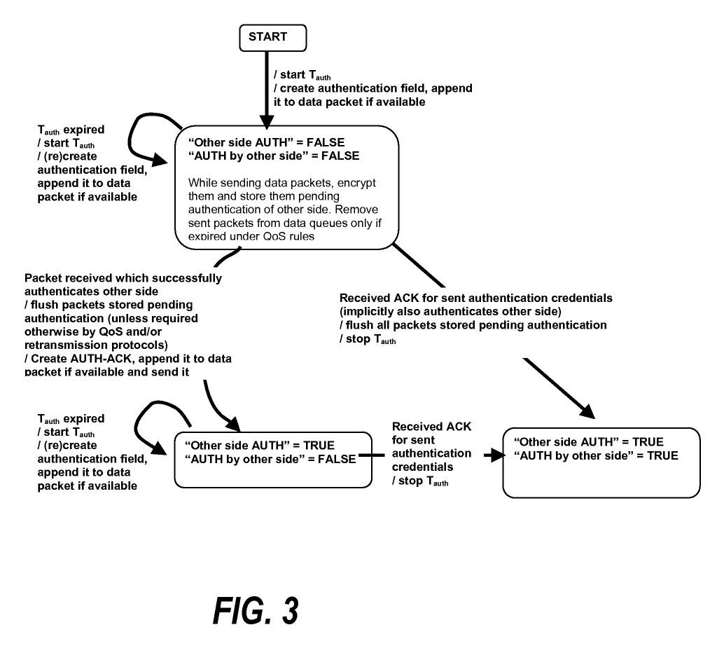

FIG. 3 represents a state diagram of the data exchange section of FIG. 2, implemented in accordance with the present invention. As used herein, the authentication key is the shared secret. The authentication field is a field containing MS or BS ID, HO-ID and possibly a session ID or nonce, signed with authentication key, and can be appended to data packets or other control messages, or can be sent in independent control message when no data or other control packet is scheduled in that direction. When appended to other data or control messages, the authentication field can also contain a portion of the message to which it is appended. Tₐᵤₜₕ is a timer controlling retransmissions of the authentication field. AUTH-ACK is an acknowledgement for receiving authentication field from other side, and contains a copy (or portion) of authentication field sent by other side and is also signed using authentication key. The ACK itself can be appended to data packets or other control messages, or can be sent in independent control message when no data or other control packet is scheduled in that direction.

In a preferred embodiment of the present invention, during a HO, both sides (MS and T-BS) implement the state diagram depicted in FIG. 2 and can act in parallel. In the following, by way of an example and to preserve the clarity of the description, we describe the set of actions taken during a HO by one side, the MS, according to a preferred embodiment of the present invention. It should be emphasized that this description in no way restricts the scope of the present invention, and that, in a preferred embodiment, the T-BS also follows similar steps according to the state diagram of FIG. 2, acting in parallel with the MS.

Before data exchange, neither side (MS or T-BS) is authenticated; i.e. AUTH=FALSE for both sides. The MS keeps two state variables, namely “other side AUTH” and “AUTH by other side”. When “other side AUTH” is set to TRUE it means that the MS has received a packet from the other side (the BS) which successfully verifies the BS′ identity, i.e. allows the MS to conclude that the BS possesses the shared secret. When “AUTH by other side” is set to TRUE it means that the MS can be certain that its own identity has been verified by the other side, i.e. the BS has successfully verified that the MS possesses the shared secret, and has successfully notified the MS of this fact.

The MS starts the Tₐᵤₜₕ timer, creates an authentication field calculated from the shared secret, an ID, and the data to be appended to, and appends the field to the data packet. If there is no data packet available the field can be sent in a control message, as previously discussed. There is no penalty for doing this as there is no data to be delayed anyway. While “other side AUTH” is FALSE, when sending data packets, the MS encrypts the data packets and stores them pending authentication of other side (the T-BS). The MS removes sent packets from sent data queues only if the packets have expired under Quality of Service (QoS) rules, as are known in the art. In particular, the MS cannot be sure of the identity of the T-BS until it successfully authenticates it. As a result, it must store sent data packets, since if authentication of T-BS fails, these packets will need to be re-sent when the MS eventually connects to a different legitimate BS (i.e. a BS which will be successfully authenticated). The only exception to this rule is when the sent packets become obsolete according to the QoS requirements of the flow to which they belong. For example, the QoS rules of a flow can stipulate that packets that are not successfully sent to the other side within fifty milliseconds become obsolete and should be discarded. In such cases the MS discards the sent packets, even though the MS cannot be sure they have been sent to a legitimate BS. This is because expired packets would still be obsolete if authentication of the BS fails and the MS connects to a legitimate BS at a later time.

Two scenarios can now arise. In a first case the sender (e.g. MS) receives a data packet from the other side (e.g. T-BS) which successfully authenticates the other side. This can happen since, as mentioned, the T-BS is also following the same state diagram depicted in FIG. 2 in parallel with the MS, and therefore sends a data packet with a signature that authenticates it at the first available opportunity (i.e. without waiting for input from the MS). In this case the MS can verify the received authentication credentials, and if authentication succeeds, successfully authenticate the T-BS. Note, however, that, since this packet was generated independently by the T-BS, the MS cannot be yet sure if the T-BS has received the authentication credentials sent earlier by the MS. In other words the MS cannot be sure if the T-BS has verified the MS's identity. In this case “Other side AUTH” is set to TRUE but “AUTH by other side” remains FALSE. The MS can then flush sent packets that were stored pending authentication, since it can now be certain that the packets were sent to a legitimate BS. The MS further creates an AUTH-ACK field, appends it to a data packet if available and sends it to the other side. The AUTH-ACK signals to the T-BS that the packet with authentication credentials that it (the T-BS) sent earlier has been successfully received and the identity of the T-BS has been successfully verified by the MS.

In a second case, the sender (e.g. MS), before receiving anything else, receives an AUTH-ACK for the authentication credentials it sent earlier to the T-BS. In this case the MS receives confirmation from the T-BS, that the authentication credentials that it (the MS) sent earlier have been successfully received and verified by the T-BS. In other words, the MS is informed that the T-BS now considers it authenticated, and it can set “AUTH by other side” to TRUE. However, since the AUTH-ACK is also signed using the shared secret and is also possibly bound to the copy of authentication credentials sent earlier by the MS (by possibly containing a copy or a portion of them), the AUTH-ACK itself can be used by the MS to verify the identity of the T-BS. The MS can now authenticate the T-BS by checking the signature contained in the AUTH-ACK, and verifying that the T-BS also possesses the shared secret. This is because only a side that possesses the shared secret can verify authentication credentials and further correctly sign acknowledgements. The MS verifies the identity of the T-BS based on the signature on the AUTH-ACK, and if it succeeds, it also sets “other side AUTH” to TRUE and can stop the Tₐᵤₜₕ timer. If the MS fails to verify the signature on the AUTH-ACK it ignores the packet and makes no changes to the state variables.

It should be noted that while “AUTH by other side” is FALSE, and when timer Tₐᵤₜₕ expires, the MS re-creates the authentication field described earlier, appends it to a data packet if available, re-sends it to the other side and restarts timer Tₐᵤₜₕ. In a preferred embodiment of the present invention a maximum can be imposed on the number of times Tₐᵤₜₕ expires and the authentication field is recreated and retransmitted before the MS declares that communication and/or mutual authentication with the specific BS is not feasible.

It should be noted that if there is no data flow in a particular direction for appending an authentication signature or an AUTH-ACK, then a control message can be simply sent with an authentication field in that direction. If no data flows exist in either direction then control messages can be used for both directions.

It is envisioned that data packets that have been sent to the other side, while authentication of the other side is pending, are stored until either: authentication of the other side succeeds and the packets are ACKed (if HARQ or ARQ is used), or the packets expire, per the QoS requirements of the flow to which they belong. If the packets expire, then there is no point in retransmitting them anyway, as they are no longer useful to the flow to which they belong. If the authentication fields need to be retransmitted they will be appended to a different packet, if available at the time of retransmission.

It is further envisioned that when one side (e.g. MS) successfully authenticates that other side (e.g. BS), packets that have been sent to the other side no longer need to be stored because of a pending authentication procedure. It should be emphasized that a pending authentication procedure is only one of the criteria potentially used by the MS to decide whether sent data packets should remain in storage or should be discarded. Consequently, even after the identity of the other side is successfully verified, sent packets can still remain in storage at the transmitting side, for other purposes, or as demanded by retransmission protocols in the physical or higher layers.

For example, when HARQ or ARQ is enabled, packets can remain in storage until they are successfully ACKed by the other side, even though authentication has already been completed.

When it is necessary for an authentication field to be retransmitted, it does not have to be appended with the same data packet as the original transmission. When the authentication field is retransmitted, it can be appended to a different data packet, or it can be put in a control packet if no data packet is available in the respective direction at that time.

In another embodiment of the present invention, the MS can choose to discard packets that have been sent to the other side and stored only when both the other side has been successfully authenticated and an AUTH ACK has been received, informing the MS that the BS has successfully verified the identity of the MS. According to this embodiment, all the rules described above are followed with the exception that data packets stored at the sending side (e.g MS) are discarded only when both “other side AUTH” and “AUTH by other side” become TRUE, instead of being discarded simply when “other side AUTH” becomes TRUE. This embodiment can be used, for example, when more reliability in the data stream is desirable.

The present invention results in considerable time savings over using control messaging. For example, authentication using control messages in one frame and resuming data communications in a next frame would not simply result in one frame of handover delay. That is because one needs to add the time required to receive, unpack and process the contents of a control message, which currently consumes about ten milliseconds extra. In other words, without a scheme that allows authentication in parallel to data exchange, an HO outage of at least fifteen milliseconds is created. Also note that if control messages need to be retransmitted, the HO outage is even longer. With the present invention, while authentication fields are being retransmitted, data packets are retransmitted as well. Advantageously, the present invention allows an MS and BS to resume data immediately during a handover, saving at least fifteen milliseconds of HO delay.

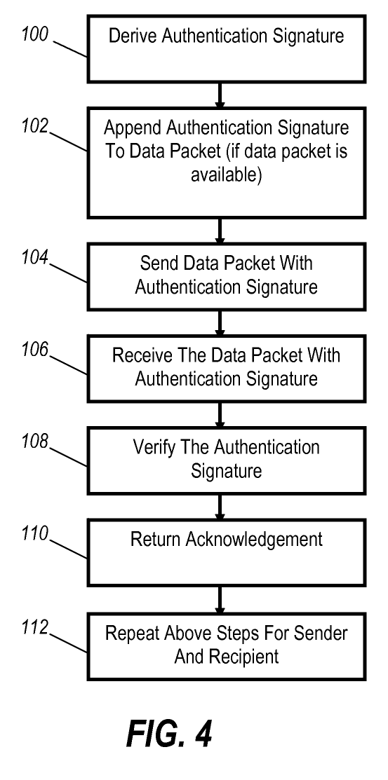

Referring to FIG. 4, the present invention also provides a method for authentication while exchanging data in a communication system. The method includes a first step of deriving 100 an authentication signature from a shared secret and data in an existing data packet by a sending communication device, such as a mobile station. The authentication signature can additionally be derived using an identification of the sender.

A next step 102 includes appending the authentication signature in an authentication field to the existing data packet by the sender (mobile station). This step can include encrypting the data packet with a pre-known key by the mobile station and storing the encrypted data packet by the mobile station until the identity of the other side is successfully verified, i.e. until the other side is authenticated.

A next step 104 includes sending the data packet with the appended authentication field by the sender (mobile station).

A next step 106 includes receiving the data packet by a recipient communication device (e.g. base station).

A next step 108 includes verifying the authentication field by the recipient device (base station) by verifying that the authentication field was produced by a sender possessing the shared secret. The recipient device (base station) can store any received data packets until the other side is authenticated, wherein if the other side is successfully authenticated the data packets are decrypted and released to an upper layer in the recipient device (base station), and if not the data packets are discarded. It should be noted that it is possible that the other side receives a multitude of data packets, wherein only the first (or a subset) of them contain authentication signatures. Then the other side stores all data packets until it verifies the authentication signatures (contained in one of or a subset of the packets) and releases or discards all of them depending on the outcome of the signature check procedure.

Further, as part of the same step 108, the recipient device (base station) when it successfully authenticates the other side (mobile station), it can discard data packets that were sent to the other side and were stored pending authentication of the other side (mobile station). Such packets exist when the receiving side has performed step 104 above, as part of step 112 below. It should be noted that that the two sides can perform these steps simultaneously (i.e. step 112). It is therefore possible that steps 100-104 can be performed simultaneously by the MS and the BS. In step 104 both sides send a data packet containing authentication field to each other and store the data packets until they verify the identity of the other side. Then when the BS in step 108 receives the packet sent by the MS in step 106, it can verify that the MS is legitimate and therefore does not need to store the packet it sent in step 104 any more.

A next step 110 includes the recipient device (base station) returning an acknowledgement message to the sending device (mobile station). Preferably, the acknowledgement message contains a portion of the received authentication field and is signed using the shared secret. The acknowledgement message can itself be appended to data packets if available at the respective direction at the time the acknowledgement message is transmitted. The sending device (MS) when it receives the acknowledgement (sent by the base station) it can use the signature contained therein to verify the identity of the base station, if another packet containing authentication information has not been received earlier. In this case, and if the authentication signature contained in the acknowledgement is successfully verified, the MS can in turn discard data packets that were sent to the other side and were stored pending authentication of the other side (base station).

A next step 112 includes repeating the above steps with the role of the sending and recipient devices (mobile station and base station) reversed to provide mutual authentication between the mobile station and base station. Preferably, these steps can be done in parallel and can be accomplished within one data frame.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for authentication while exchanging data in a communication system, the method comprising the steps of:
appending an authentication field to an existing data packet by a sender;
sending the data packet with the appended authentication field by the sender; and
receiving the data packet by a recipient;
verifying information in the authentication field by the recipient by verifying that the information was produced by a sender possessing a shared secret.

2. The method of claim 1, wherein the information in the authentication field of the appending step includes an authentication signature derived from a shared secret and the data in the data packet.

3. The method of claim 2, wherein the information in the authentication field of the appending step includes the authentication signature being further derived from an identification of the sender.

4. The method of claim 1, wherein after the appending step further comprising the steps of:
encrypting the data packet with a pre-known key; and
storing the encrypted data packet.

5. The method of claim 1, further comprising the step of returning an acknowledgement message to the sender.

6. The method of claim 5, wherein the acknowledgement message contains a portion of the received authentication field.

7. The method of claim 5, wherein the acknowledgement message contains a signature derived from a shared secret.

8. The method of claim 1, further comprising the step of the recipient storing the received data packets until the sender is authenticated, wherein if the sender is authenticated the data packets are decrypted and released to an upper layer in the recipient, and if the sender is not authenticated the data packets are discarded.

9. The method of claim 1, further comprising the step of the sender storing the sent data packets until it receives an authentication from the recipient, wherein if an authentication is received the sender discards the packets that were sent and stored.

10. The method of claim 1, further comprising the step of repeating the above steps with the role of the sender and recipient reversed so as to provide mutual authentication between the sender and recipient.

11. A method for authentication while exchanging data in a communication system, the method comprising the steps of:
deriving an authentication signature from a shared secret and data in an existing data packet by a mobile station;
appending the authentication signature in an authentication field to the existing data packet by the mobile station;
sending the data packet with the appended authentication field by the mobile station; and
receiving the data packet by a base station;
verifying the authentication field by the base station by verifying that the authentication field was produced by a sender possessing the shared secret.

12. The method of claim 11, wherein the deriving step includes further deriving the authentication signature from an identification of the mobile station.

13. The method of claim 11, wherein after the appending step further comprising the steps of:
encrypting the data packet with a pre-known key by the mobile station; and
storing the encrypted data packet by the mobile station until the base station is authenticated.

14. The method of claim 11, further comprising the step of the base station returning an acknowledgement message to the mobile station.

15. The method of claim 14, wherein the acknowledgement message contains a portion of the received authentication field.

16. The method of claim 14, wherein the acknowledgement message contains a signature derived from a shared secret.

17. The method of claim 11, further comprising the step of the base station storing the received data packets until the mobile station is authenticated, wherein if the mobile station is authenticated the data packets are decrypted and released to an upper layer in the base station, and if the mobile station is not authenticated the data packets are discarded.

18. The method of claim 11, further comprising the step of the mobile station storing the sent data packets until it receives an authentication from the base station, wherein if an authentication is received the mobile station discards the packets that were sent and stored.

19. The method of claim 11, further comprising the step of repeating the above steps with the role of the mobile station and base station reversed to provide mutual authentication between the mobile station and base station.

20. A system for authentication while exchanging data in a communication system between a mobile station and a base station:
a sending communication unit that appends an authentication field to an existing data packet and sends the data packet with the appended authentication field by the sender; and
a recipient communication unit that receives the data packet and verifies the information in the authentication field by verifying that the information was produced by a sender possessing a shared secret.
